(19) United States
(12) Patent Application Publication
(10) Pub. No.: US 2015/0077751 A1
(43) Pub. Date: Mar. 19, 2015

(54) METHOD FOR OPTICAL INSPECTION AND SYSTEM THEREOF

(71) Applicant: INDUSTRIAL TECHNOLOGY RESEARCH INSTITUTE, Hsinchu (TW)

(72) Inventors: Yi-Chen HSIEH, Pitou Township (TW); Fu-Cheng YANG, Xinpu Township (TW); Chih-Jung CHIANG, Zhubei City (TW)

(73) Assignee: INDUSTRIAL TECHNOLOGY RESEARCH INSTITUTE, Hsinchu (TW)

(21) Appl. No.: 14/144,284

(22) Filed: Dec. 30, 2013

(30) Foreign Application Priority Data
Sep. 16, 2013 (TW) 102133441

(51) Int. Cl. G01N 21/21

(52) U.S. Cl. CPC G01N 21/21
USPC 356/369

(57) ABSTRACT

An optical inspection system suitable for inspecting a thin film is provided, in which a computer controls a controller to rotate angles of at least two of a polarization device, a phase compensation device and an analyzer at various incident wavelengths and incident angles of a light source, such that the intensities of a first image corresponding to the incident wavelengths and the incident angles of the light source are zero. The computer further records the rotated angles of at least two of the polarization device, the phase compensation device and the analyzer and intensities of a second image corresponding to the incident wavelengths and the incident angles when the intensities of the first image are zero, thereby obtaining a profiling diagram and a maximum intensity of the second images, in which the maximum intensity corresponds to a maximum grey level.

### CROSS REFERENCE TO RELATED APPLICATION

This application claims priority of Taiwan Patent Application No. 102133441, filed on Sep. 16, 2013, the entirety of which is incorporated by reference herein.

### TECHNICAL FIELD

The disclosure relates to a method for optical inspection and system thereof.

### BACKGROUND

Poly crystalline silicon (poly-Si) is a material made up of small silicon grains. Poly-Si is usually formed by annealing with temperatures higher than 900° C. However, the deformation temperature of glass is only 650° C., and thus a laser is usually used for illuminating the amorphous silicon (a-Si) on the glass substrate used in semiconductor manufacturing. After the a-Si absorbs the energy of the laser, the a-Si transforms into the poly-Si. The process of laser annealing is performed below the deformation temperature of glass; hence the laser annealing method is suitable for the glass substrate. The poly-Si made by said method is usually called low-temperature poly-silicon (LTPS). The thin-film transistor liquid crystal displays (TFT-LCD) made by LTPS have the advantages of high brightness, high resolution, and low power consumption because the carrier mobility of the poly-Si is higher than that of the a-Si.

However, the laser power used for annealing is sometimes unstable. Therefore, the grain size on the glass substrate is not uniform, so the poly-Si thin film is not uniform. The conventional automatic optical inspection (AOI) method usually uses ellipsometry technologies to inspect the thickness of the thin film. The ellipsometry technologies include spectrum ellipsometry technology and image ellipsometry technology. The spectrum ellipsometry technology uses a wideband light source and is used for measuring the changes of a refractive index of the LTPS, and the crystalline characterizations of the LTPS can be obtained by the changes of the refractive index. However, the inspection range of the spectrum ellipsometry technology is confined to the spot size of the inspecting light. Two dimensional scanning performed by the moving stage is needed to obtain all information (plane information) of the thin film, and thereby the scanning time is too long. Besides, the image contrast of the spectrum ellipsometry technology is disappointing. The inspection range of the image ellipsometry technology is also confined to a narrow range. Besides, it is unable to perform the in situ inspection because the conventional ellipsometry technologies do not have the function of classifying the samples.

### SUMMARY

Therefore, a method for optical inspection and system thereof are needed.

The disclosure provides a method for automatic optical inspecting of a thin film comprising a first material and a second material, including the steps of: illuminating the thin film with a light generated from a light source, collecting a reflected light reflected by the thin film by a light sensor, and forming a first image and a second image respectively corresponding to the first material and the second material according to intensity of the reflected light collected by the light sensor; disposing a polarization device in an optical axis between the light source and the thin film, to linearly polarize incident light to have a P-polarization wave and an S-polarization wave; disposing an analyzer in the optical axis between the thin film and the light sensor; disposing a phase compensator device in one of the optical axes for compensating for a phase shift between the P-polarization wave and the S-polarization wave caused by one of the first and second materials; setting a wavelength of the incident light generated from the light source to a first incident wavelength, and rotating at least two of the polarization device, the analyzer and the phase compensator device around the corresponding optical axes in a plurality of incident angles such that intensities of the first images in each of the incident angles equal to zero; recording rotating angles of the at least two of the polarization device, the analyzer, and the phase compensator device around the corresponding optical axes when the intensities of the first images is equal to zero, and recording intensities of the second image in the first incident wavelength and incident angles; changing a wavelength of the incident light generated from the light source to another incident wavelength, and rotating at least two of the polarization device, the analyzer and the phase compensator device around the corresponding optical axes in the plurality of incident angles such that the intensities of the first images in each of the plurality of incident angles equal to zero; recoding rotating angles of the at least two of the polarization device, the analyzer and the phase compensator device around the corresponding optical axes when intensities of the first images are equal to zero, and recording intensities of the second image in the rotating angles; and repeating the steps of changing the incident wavelengths and incident angles, to obtain a profiling diagram representing the intensities of the second images in various incident wavelengths and incident angles and a maximum intensity of the second images, in which the maximum intensity corresponds to a maximum grey level.

The disclosure provides an optical inspection system suitable for inspecting a thin film, in which the thin film including a first material and a second material, the optical inspection system including: a light source configured to generate a light to illuminate the thin film; a polarization device disposed in the optical axis between the light source and the thin film and configured to linearly polarize an incident light generated from the light source to have a P-polarization wave and a S-polarization wave; a phase compensator device disposed in one of said optical axes and configured to compensate a phase shift between the P-polarization wave and the S-polarization wave caused by one of the first and second materials; a light sensor configured to collect a reflected light reflected by the thin film and to form a first image and a second image respectively corresponding to the first material and the second material according to an intensity of the reflected light collected by the light sensor, and to transform the first image and the second image into corresponding electronic signals; a analyzer disposed in the optical axis between the thin film and the light sensor; a controller configured to receive a set of controlling signals and generates adjusting signals to adjust rotating angles of at least two of the polarization device, the analyzer and the phase compensator device around the corresponding optical axes and adjust incident angles and wavelengths of the light source; and an electronic computer coupled between the light sensor and the controller and configured to output the set of controlling signals to control the controller to rotate the rotating angles of at least two of the polarization device, the analyzer and the phase compensator device around the corresponding optical axes in various incident wavelengths and/or incident angles such that the intensities of the first images to be equal to zero. The electronic computer further records the rotating angles of the at least two of the polarization device, the analyzer and the phase compensator device around the corresponding optical axes when the intensities of the first images are equal to zero and records a plurality of intensities of the second images to obtain a profiling diagram representing the intensities of the second images in various incident wavelengths and incident angles and a maximum intensity of the second images, wherein the maximum intensity corresponds to a maximum grey level.

A detailed description is given in the following embodiments with reference to the accompanying drawings.

### BRIEF DESCRIPTION OF DRAWINGS

The disclosure can be more fully understood by reading the subsequent detailed description and examples with references made to the accompanying drawings, wherein:

FIG. 1 depicts a diagram of an optical inspection system 1 according to an embodiment of the disclosure;

FIG. 2A is a microscopic image of the testing sample according to the embodiment of the disclosure;

FIG. 2B is a simplified diagram of the testing sample 12 for illustrating the optical inspection method according to an embodiment of the disclosure;

FIG. 3 is a flow chart according to an embodiment of the disclosure;

FIG. 4A is a detailed flowchart of step S100 in FIG. 3 and shows the method to improve image contrast according to the disclosure;

FIG. 4B is a detailed flowchart of step S200 and S300 in FIG. 3 and shows the method for a semi-quantitative analysis of the thin film according to the disclosure;

FIG. 4C is a look-up table according to an embodiment of the disclosure; and

FIG. 5 is a profiling diagram representing the intensities of the second images in various incident wavelengths and incident angles according to an embodiment of the disclosure.

### DETAILED DESCRIPTION

The following description is made for the purpose of illustrating the general principles of the disclosure and should not be taken in a limiting sense. The scope of the disclosure is best determined by reference to the appended claims.

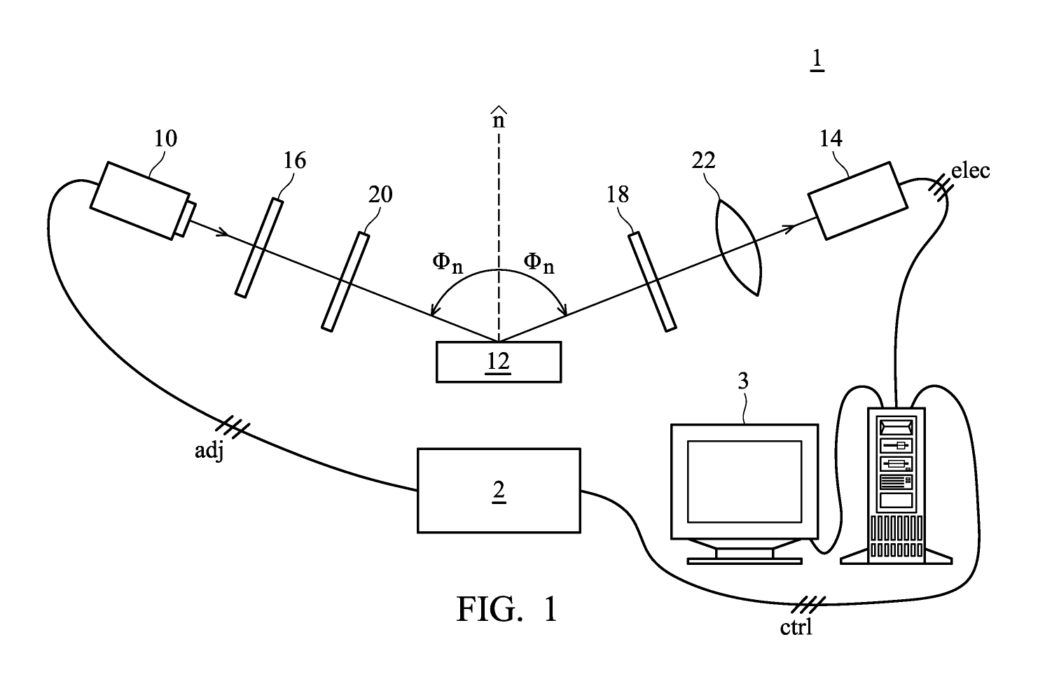

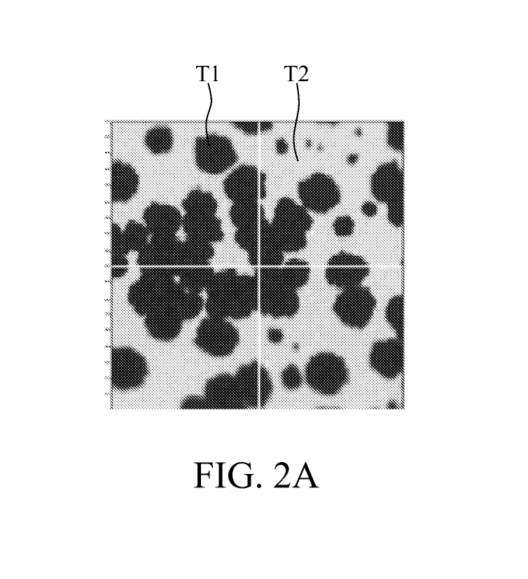

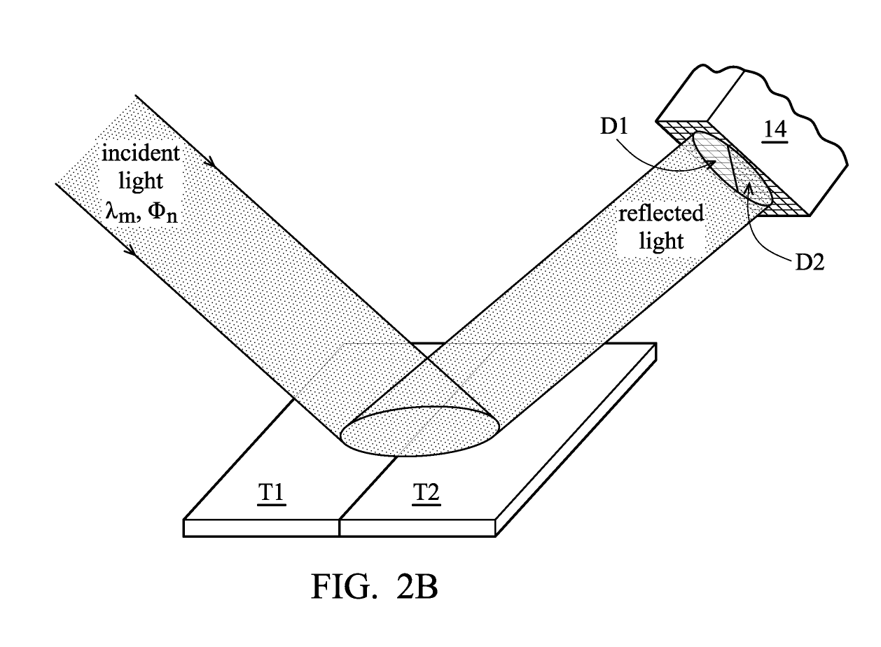

FIG. 1 depicts a diagram of an optical inspection system 1 according to an embodiment of the disclosure. In an embodiment, the optical inspection system 1 includes a light source 10, testing sample 12 and a light sensor 14. FIG. 2A is a microscopic image of the testing sample according to the embodiment of the disclosure. As shown in FIG. 2A, testing sample 12 is an amorphous silicon (a-Si) thin film annealed by laser annealing and includes a first material T1 (shadow part) and a second material T2 (other part). Refer to FIG. 1: the light source generates unpolarized (i.e. circular) light, and the incident light is incident to testing sample 12 with incident angle (D_{N}. The light sensor 14 collects the light reflected by the testing sample 12, wherein N=1˜n and n is a positive integer. When the optical inspection system 1 has the same configuration, the light sensor 14 collects reflected light having different intensities and forms a first image and a second image respectively corresponding to the first material and the second material because the first and second materials have different optical properties. Besides, the optical sensor 14 transforms the first image and second image into corresponding electronic signals. In the embodiment, the light source 10 is a wideband spectrum surface light source, the incident wavelength λ_{M} of the light source 10 is between 250 and 840 nm, M=1˜m, and m is a positive integer. In the embodiment, the light sensor 14 is a charge coupled device (CCD) array or a complementary metal oxide (CMOS) semiconductor array, and further includes an imaging lens 22 for collimating reflected light.

In the embodiment, the optical inspection system 1 further includes a polarization device 16, an analyzer 18 and a phase compensator 20. The polarization device 16 is disposed in the optical axis between the light source 10 and testing sample 12 and configured to linearly polarize the incident light to have a P-polarization wave and a S-polarization wave, in which the P-polarization wave represents the oscillation direction of electric field of the light being parallel to the incident plane and the S-polarization wave represents the oscillation direction of electric field of the light perpendicular to the incident plane. The analyzer 18 is disposed in the optical axis between the testing sample 12 and the light sensor. As shown in FIG. 1, the phase compensator 20 is disposed in the optical axis between the polarization device 16 and the testing sample 12 and configured to compensate the phase shift between the P-polarization wave and the S-polarization wave caused by one of said materials. In other embodiment, the phase compensator 20 is disposed in the optical axis between the testing sample 12 and the analyzer 18. The polarization device 16, the analyzer 18 and the phase compensator 20 of the optical inspection system rotate around the optical axes for compensating the phase shift between the P-polarization wave and the S-polarization wave.

In the embodiment, the optical inspection system 1 further includes a controller 2 and an electronic computer 3. The electronic computer 3 is coupled to the light sensor 14. The electronic computer 3 is configured to set or change the incident wavelength and incident angle of the light source 10 and record the rotating angles of the polarization device 16, the analyzer 18 and the phase compensator 20. Besides, the electronic computer 3 receives and records the electronic signals elec generated from the light sensor 14, in which the electronic signals elec represent the intensities of the first image and the second image. The electronic computer 3 generates the corresponding control signals ctrl. The controller 2 is coupled between the electronic computer 3 and light source 10. The controller 2 receives the corresponding control signals ctrl and generates the adjusting signals adj to adjust the incident wavelength λ_{M} and incident angle Φ_{N} of the light source 10, and thus obtain a profiling diagram representing the intensities of the second images in various incident wavelengths and incident angles and a maximum intensity of the second images, in which the maximum intensity corresponds to a maximum grey level g_{2M}. In FIG. 1, the controller 2 is not depicted being coupled to the polarization device 16, the analyzer 18 and the phase compensator 20; however, the controller 2 is coupled to the polarization device 16, the analyzer 18 and the phase compensator 20 in another embodiment.

FIG. 2B is a simplified diagram of the testing sample 12 illustrating the optical inspection method according to an embodiment of the disclosure. Refer to FIG. 2B: the testing sample 12 includes a first material T1 and a second material T2. In the embodiment, the first material T1 represents a-Si and the second material represents polycrystalline silicon (poly-Si). As mentioned above, the incident light is incident to the testing sample 12 with incident angle Φ_{N} and incident wavelength λ_{M}, the incident light partially illuminates the first material T1 and the second material T2, and hence the imaging array of the light sensor 14 respectively receives the light reflected from the first material and the second material. By measuring the ratio (i.e. r_{P}/r_{S}|_{S1}) of a P-polarization wave rₚ reflected by the first material T1 and a S-polarization wave rₛ reflected by the second material and the ratio (i.e. r_{P}/r_{S}|_{S2}) of reflected P-polarization wave rₚ reflected by the second material T2 and reflected S-polarization wave rₛ reflected by the second material T2, the ellipsometric parameters Ψ_{T1}(Φₙ, λₘ); Δ_{S1}(Φₙ, λₘ) and Ψ_{T2}(Φₙ, λₘ); Δ_{S2}(Φₙ, λₘ) of the first material T1 and second material T2 in incident angle Φₙ and incident wavelength λₘ can be obtained. The ratio relationship of the reflected polarization waves can be expressed as follows:

$$\frac{{r}_{P}}{{r}_{S}} {\vert}_{T 1} = tan ( {Ψ}_{T 1} ) {e}^{i {Δ}_{T 1}}$$

$$\frac{{r}_{P}}{{r}_{S}} {\vert}_{T 2} = tan ( {Ψ}_{T 2} ) {e}^{i {Δ}_{T 2}}$$

wherein tan (Ψ_{T1}) and tan (Ψ_{T2}) respectively express the ratio of the amplitudes of the reflected S- and P-polarization waves, and Δ_{T1} and Δ_{T2} respectively express the phase differences of the reflected S- and P-polarization waves. The Jones matrices representing the first material T1 and second material T2 can be obtained by appropriately assuming the physical model that represents the polarized light reflected by the materials. For brevity, many details will not be addressed herein.

Refer to FIG. 1: the light generated from the light source 10 sequentially passes through the polarization device 16 and the phase compensator 20. After passing through the phase compensator 20, the light is reflected by the testing sample 12 (i.e. the first material T1 and the second material T2) and passes the analyzer 18. After passing through the analyzer 18, the light is collected by the light sensor 14. In the embodiment, the light is assumed to be fully polarized, and the intensity and phase will not be changed after passing through the analyzer 22. Therefore, the Jones Matrix of the light that is collected by the light sensor 14 can be obtained by multiplying the Jones Matrix of the light generated from the light source 10 with the Jones Matrices of the optical elements which the light sequentially passed through. Specifically, the Jones Matrices of the light that is collected by the light sensor 14 ([D1]_{2×1} and [D2]_{2×1}) can be obtained by sequentially left multiplying the Jones Matrix of the light generated from the light source 10 ([S]_{2×1}) with the Jones Matrix representing the polarization device 16 ([P]_{2×2}), the Jones Matrix representing the phase compensator 20 ([C]_{2×2}), the Jones Matrices representing the first material T1 and second material T2 ([T1]_{2×2} and [T2]_{2×2}), and the Jones Matrix representing the analyzer 18 ([A]_{2×2}). The left multiplying process can be expressed as follows:

[A]_{2×2}[T1]_{2×2}[C]_{2×2}[P]_{2×2}[S]_{2×1}=[D1]_{2×1}

[A]_{2×2}[T2]_{2×2}[C]_{2×2}[P]_{2×2}[S]_{2×1}=[D2]_{2×1}

wherein

$$[ S ] = ( \begin{matrix}{E}_{x} {e}^{{iδ}_{x}} \\ {E}_{y} {e}^{{iδ}_{y}}\end{matrix} ) ,$$

Ex and Ey represent the x and y components of the amplitudes of the electrical fields of the light generated from the light source, and δₓ and δ_{y} represent the x and y components of the phases of the light generated from the light source, and i²=−1.

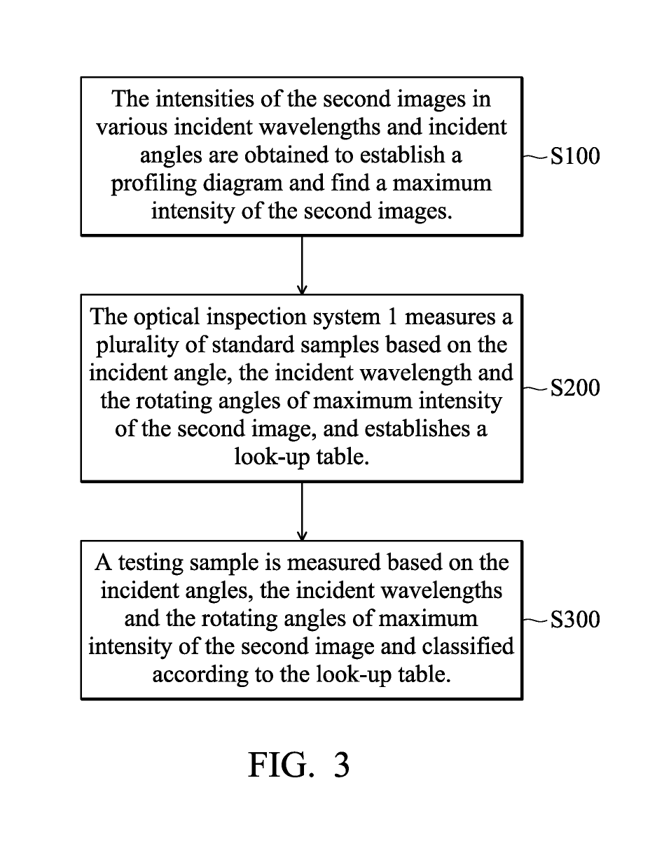

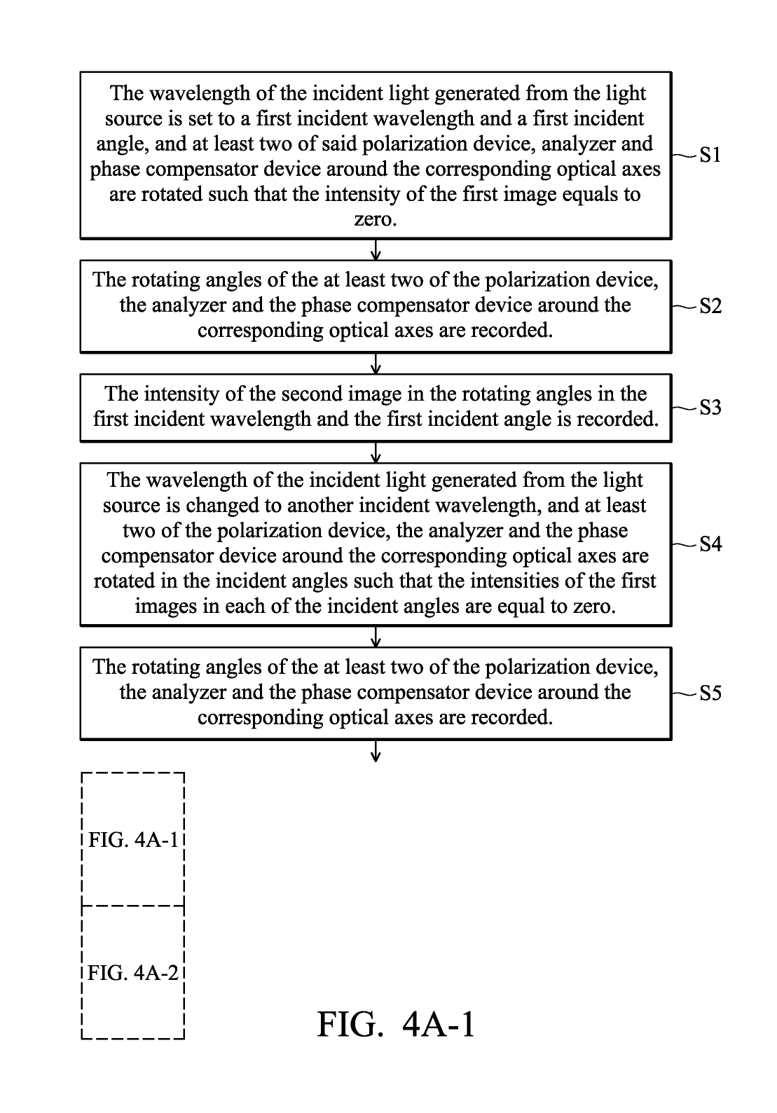

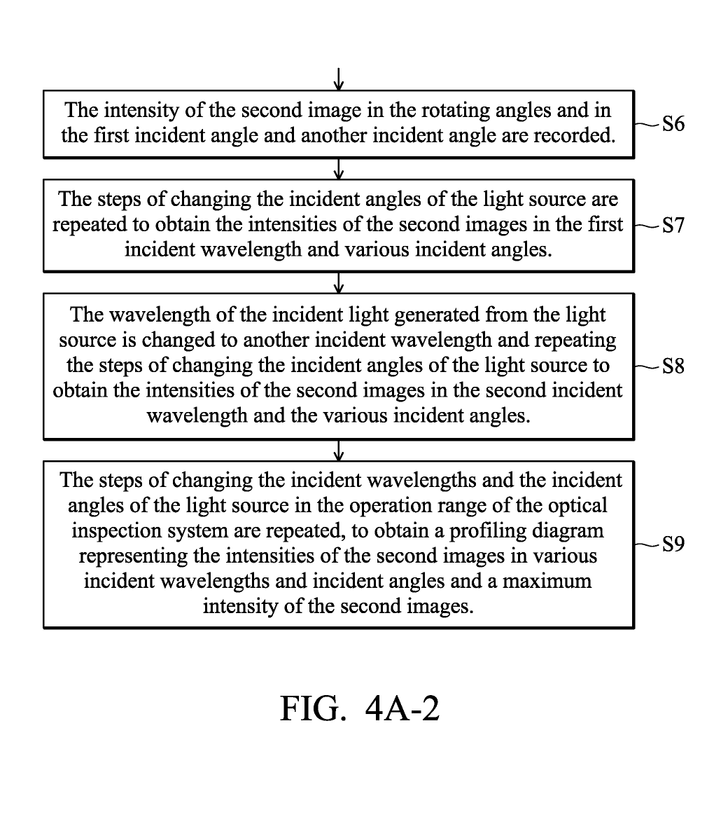

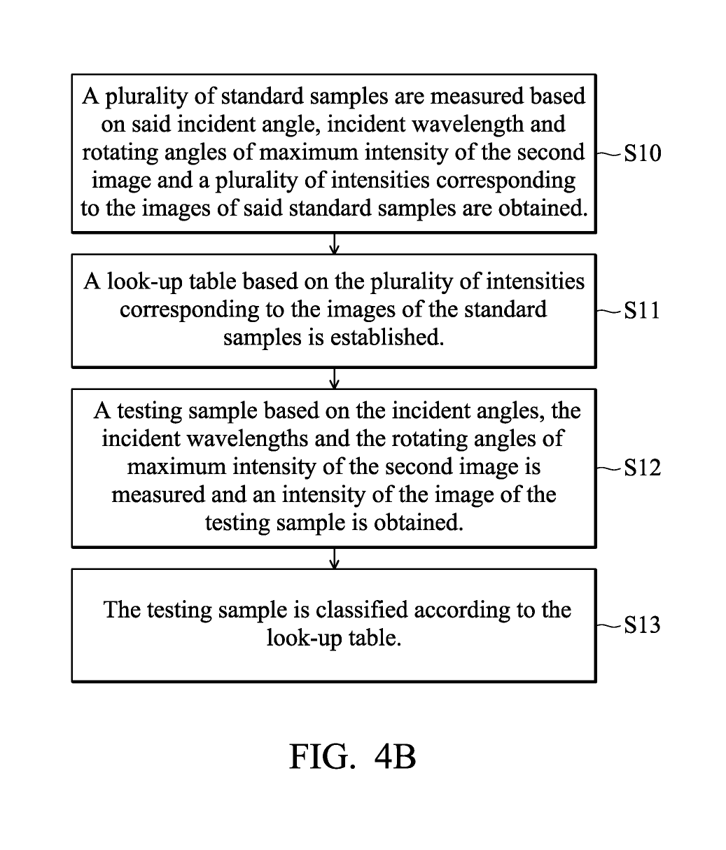

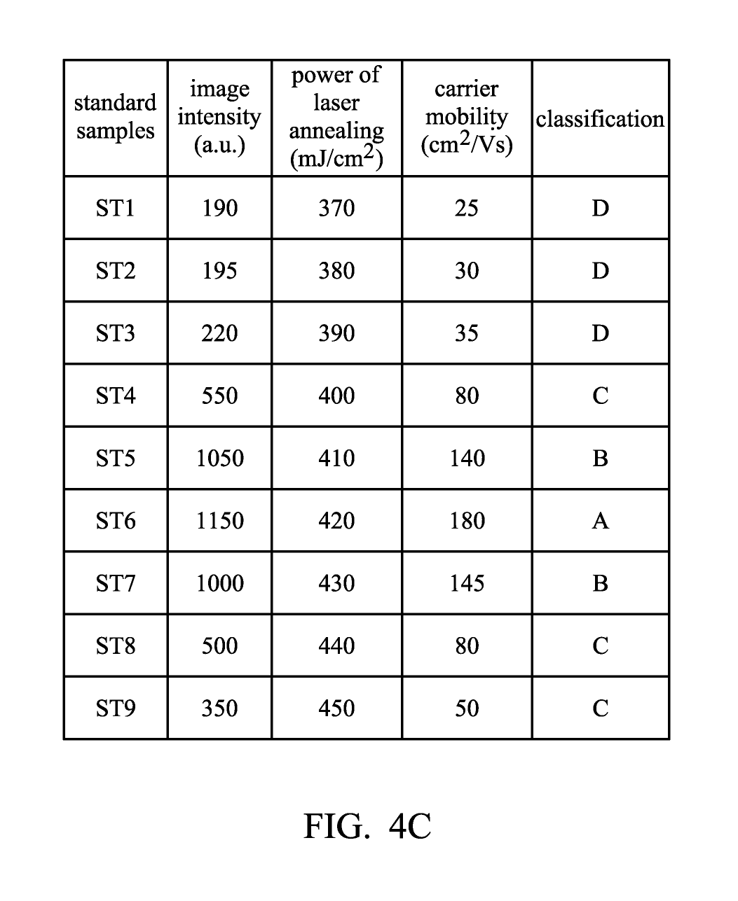

FIG. 3 is a flow chart according to an embodiment of the disclosure. In step S100, the image intensities of the second material (the intensities of the second images) in various incident wavelengths and incident angles are obtained to establish a profiling diagram and find a maximum intensity of the second images. For example, the electronic computer 3 outputs the controlling signals ctrl to control the controller 2, and the controller 3 receives the controlling signals ctrl and generates adjusting signals adj to adjust rotating angles of at least two of the polarization device 16, the analyzer 20 and phase compensator device 18 around the corresponding optical axes such that the intensities of the first images equal to zero in various incident wavelengths and incident angles. The electronic computer 3 further records the rotating angles of the at least two of the polarization device 16, the analyzer 20 and phase compensator device 18 around the corresponding optical axes when the intensities of the first images are equal to zero, and records a plurality of intensities of the second images to obtain a profiling diagram representing the intensities of the second images in various incident wavelengths and incident angles and a maximum intensity of the second images. In some embodiments, the maximum intensity corresponds to a maximum grey level. In step S200, the optical inspection system 1 measures a plurality of standard samples based on said incident angle, incident wavelength and rotating angles of maximum intensity of the second image, and establishes a look-up table. In step 300, a testing sample is measured based on said incident angles, incident wavelengths and rotating angles of maximum intensity of the second image and classified according to the look-up table. The details of the step S100, S200 and S300 will be explained in FIG. 4A and FIG. 4B.

FIG. 4A is a detailed flowchart of step S100 in FIG. 3 and shows the method to improve image contrast according to the disclosure. In step S1, the wavelength of the incident light generated from the light source is set to a first incident wavelength and a first incident angle, and at least two of said polarization device, analyzer and phase compensator device around the corresponding optical axes are rotated such that the intensity of the first image equals zero. In the embodiment, the electronic computer 3 sets the wavelength of the incident light generated from the light source 10 to a first incident wavelength λ₁ and a first incident angle Φ₁, and manually rotates the polarization device 16 and the phase compensator 20 such that the electronic signal g₁(Φ₁, λ₁) representing the intensity of the first image shows the intensity of the first image is equal to zero. In another embodiments, the controller 2 receives the controlling signals ctrl from the electronic computer 3 and generates the adjusting signals adj to rotate at least two of said polarization device 16, analyzer and phase compensator device 20 such that the electronic signal g₁(Φ₁, λ₁) representing the intensity of the first image shows the intensity of the first image is equal to zero.

In step S2, the rotating angles of the at least two of said polarization device, analyzer and phase compensator device around the corresponding optical axes are recorded. In the embodiment, the electronic computer 3 records the rotating angles of the polarization device 16 and the phase compensator device 20 around the optical axes (P1 and C1), but is not limited thereto. In other embodiment, the electronic computer 3 records the rotating angles of the polarization device 16 and the analyzer 18, or the rotating angles of the analyzer 18 and the phase compensator device 20 when the polarization device 16 and the analyzer 18, or the analyzer 18 and the phase compensator device 20 is rotated.

In step S3, the intensity of the second image in the said rotating angles in the first incident wavelength and first incident angle is recorded. In the embodiment, the electronic computer 3 records the electronic signal g₂(Φ₁, λ₁) representing the intensity of the second image in the said rotating angles P1 and C1 and in the first incident wavelength λ₁ and first incident angle Φ₁.

In step S4, the wavelength of the incident light generated from the light source to another incident wavelength is changed, and at least two of said polarization device, analyzer and phase compensator device around the corresponding optical axes in said incident angles are rotated such that the intensities of the first images in each of the incident angles are equal to zero. In the embodiment, the controller 2 receives the control signals ctrl and generates corresponding adjusting signals adj to change the incident angle to a second incident angle Φ₂, and manually rotates the polarization device 16 and the phase compensator 20 such that the electronic signal g₂(Φ₂, λ₁) representing the intensity of the first image shows the intensity of the first image equal to zero. In another embodiments, the controller 2 receives the control signals ctrl from the electronic computer 3 and generates the adjusting signals adj to rotate at least two of the polarization device 16, the analyzer 18 and the phase compensator 20 such that the electronic signal g₂(Φ₂, λ₁) representing the intensity of the first image shows that the intensity of the first image is equal to zero.

In step S5, the rotating angles of the at least two of the polarization device, the analyzer and the phase compensator device around the corresponding optical axes are recorded. In the embodiment, the electronic computer 3 records the rotating angles (P2 and C2) of the polarization device 16 and the phase compensator device 20 around the corresponding optical axes. In the other embodiment, the electronic computer records the rotating angles of the polarization device 16 and the analyzer 18, or the analyzer 18 and the phase compensator device 20 around the corresponding optical axes.

In step S6, the intensity of the second image in the said rotating angles and in the first incident angle and another incident angle are recorded. In the embodiment, the electronic computer 3 records the electronic signal g₂(Φ₂, λ₁) representing the intensity of the second image in the rotating angles P2 and C2 and in the first incident wavelength λ₁ and the second incident angle Φ₂.

In step S7, the steps of changing the incident angles of the light source to obtain the intensities of the second images in the first incident wavelength and various incident angles are repeated. In the embodiment, the electronic computer 3 repeats steps S4 to S6 to obtain the electronic signals g₂(Φ₁˜Φ_{N}, λ₁) representing the intensities of the second images in the first incident wavelength and various incident angles.

In step S8, the wavelength of the incident light generated from the light source to another incident wavelength are changed and the steps of changing the incident angles of the light source to obtain the intensities of the second images in the second incident wavelength and the various incident angles are repeated. In the embodiment, the electronic computer 3 changes the incident wavelength of the light source 10 to the second incident wavelength λ₂ and repeats the step S7 to obtain the electronic signals g₂(Φ₁˜Φ_{N}, λ₂) representing the intensities of the second images in the second incident wavelength λ₂ and the various incident angles.

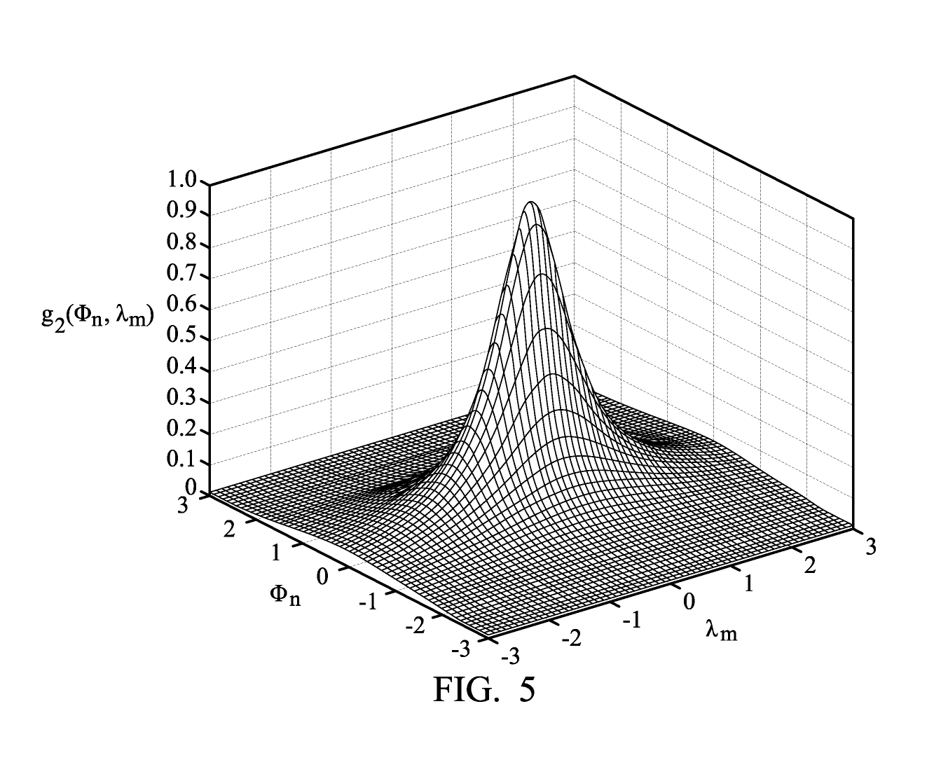

In step S9, the steps of changing the incident wavelengths and the incident angles of the light source in the operation range of the optical inspection system are repeated to obtain a profiling diagram representing the intensities of the second images in various incident wavelengths and incident angles and a maximum intensity of the second images. In the embodiment, the electronic computer 3 repeats the step S8 and thereby obtains a profiling diagram (see FIG. 5) of the electronic signals g₂ (Φ₁˜Φ_{N}, λ₁˜λ_{M}) representing the intensities of the second images in various incident wavelengths and incident angles and obtains a maximum intensity of the second images. In some embodiments, the intensities of the second images is expressed with grey levels, and the electronic signal g_{2M} representing the maximum intensity of the second image corresponds to a maximum grey level.

Refer to FIG. 4B, which is a detailed flowchart of steps S200 and S300 in FIG. 3 and shows the method for a semi-quantitative analysis of the thin film according to the disclosure. In some embodiments, step S200 includes the step S10 and the step S11, and the step S300 includes the step S12 and the step S13, but it is not limited thereto. In the step S10, a plurality of standard samples are measured based on said incident angle, incident wavelength and rotating angles of maximum intensity of the second image and a plurality of intensities corresponding to the images of said standard samples are obtained, in which the standard samples represent the thin films being annealed with different laser power. In the embodiment, the electronic computer 3 measures a plurality of standard samples ST1˜STN based on said incident angle, incident wavelength and rotating angles of maximum intensity of the second image and obtains a plurality of intensities corresponding to the images of said standard samples ST1˜STN.

In the step S11, a look-up table based on the a plurality of intensities corresponding to the images of said standard samples is established, in which the look-up table represents the relationship between said intensities corresponding to the images of said standard samples, the power of laser annealing of said standard samples and the carrier nobilities of said standard samples. In the embodiment, refer to FIG. 4c, in which the electronic computer 3 records a plurality of intensities corresponding to the images of said standard samples to establish a look-up table (LUT), in which the look-up table represents the relation between said intensities corresponding to the images of said standard samples, the power of laser annealing of said standard samples and the carrier nobilities of said standard samples. In the embodiment, the intensity is an arbitrary unit (a.u.), and the intensities can be expressed by the gray levels in another embodiment.

In the step S12, a testing sample based on said incident angles, incident wavelengths and rotating angles of maximum intensity of the second image is measured and an intensity of the image of said testing sample is obtained. In the embodiment, the electronic computer 3 measures a testing sample based on said incident angles, incident wavelengths and rotating angles of maximum intensity of the second image and obtains an intensity of the image of said testing sample.

In the step S13, the testing sample is classified according to the look-up table. In the embodiment, one can find a row in the LUT representing the image intensity of the testing sample, the power of laser annealing of the testing sample, and the carrier nobilities of the testing sample, and thus can classify the testing sample. For example, refer to FIG. 4C: the standard samples are classified as A, B, C and D classes according to carrier mobility. Class A represents the carrier mobility being greater than 150 cm²/Vs, class B represents the carrier mobility being between 100 and 150 cm²/Vs, class C represents the carrier mobility being between 50 and 100 cm²/Vs, and class D represents the carrier mobility is less than 50 cm²/Vs. In order to maintain the same quality of production, the testing samples are identified as obsolete when the testing samples are classified as class B, C and D. In other embodiments, the maximum image intensity is set as a threshold. When the image intensity is less than 1,150 a.u., we know that the power of laser annealing has been changed. The power of the laser should be adjusted.

At the same incident wavelength and incident angle, the intensities of the first images are forced to be equaled to zero by rotating at least two of the polarization device, the analyzer and the phase compensator device. The intensities of the second image in the rotating angles are recorded, and the steps of changing the incident angles are repeated to obtain the intensities of the second images in the first incident wavelength and the various incident angles. Then, the first incident wavelength is changed to a second incident wavelength and the steps of changing incident angles to obtain the intensities of the second images are repeated for the second incident wavelength and the various incident angles. Finally, the steps of changing the incident wavelengths and incident angles are repeated to obtain a profiling diagram representing the intensities of the second images in various incident wavelengths and incident angles and a maximum intensity of the second images. In the process of changing the incident wavelengths and incident angles, the disclosure provides a method for optical inspection and a system thereof for improving the image contrast by making the intensities of the first images equal to zero and measuring the intensities of the second images at the same time.

The disclosure provides a method for optical inspection and a system thereof, further including measuring a plurality of standard samples based on the incident angle, the incident wavelength and the rotating angles of maximum intensity of the second images and obtaining a plurality of intensities corresponding to the images of said standard samples, wherein the standard samples represents the thin films annealed with different laser power. The method for optical inspection further including establishing a look-up table, wherein the look-up table represents the relationship between the intensities corresponding to the images of the standard samples, the power of laser annealing of the standard samples and the carrier nobilities of said standard samples; measuring a testing sample based on the incident angles, the incident wavelengths and the rotating angles of maximum intensity of the second images, and obtaining an intensity of the image of the testing sample; measuring a testing sample based on the incident angles, the incident wavelengths and the rotating angles of the maximum intensity of the second images, and obtaining an intensity of the image of the testing sample; and classifying the testing sample according to the look-up table. After the optics configuration of maximum image contrast of the optical inspection system is determined, the disclosure provides a method for optical inspection and a system thereof for classifying the testing samples in situ by establishing the LUT representing the standard samples.

The optical conjuration of the disclosure is polarization device/phase compensator/sample/analyzer (PCTA), but it is not limited thereto. In other embodiments, the optics conjuration of the disclosure is PTA, PCTCA or the same.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for an automatic optical inspection of a thin film comprising a first material and a second material, comprising the steps of:
(1) illuminating the thin film with a light generated from a light source, collecting a reflected light reflected by the thin film by a light sensor, and forming a first image and a second image respectively corresponding to the first material and the second material according to an intensity of the reflected light collected by the light sensor;
(2) disposing a polarization device in an optical axis between the light source and the thin film, to linearly polarize an incident light from the light source to have a P-polarization wave and a S-polarization wave;
(3) disposing an analyzer in an optical axis between the thin film and the light sensor;
(4) disposing a phase compensator device in one of the optical axes for compensating a phase shift between the P-polarization wave and the S-polarization wave caused by one of said materials;
(5) setting a wavelength of the incident light generated from the light source to a first incident wavelength, and rotating at least two of the polarization device, the analyzer and the phase compensator device around the corresponding optical axes in a plurality of incident angles such that intensities of the first images in each of the plurality of incident angles is equal to zero;
(6) recording rotating angles of the at least two of the polarization device, the analyzer and the phase compensator device around the corresponding optical axes when the intensities of the first images are equal to zero, and recording intensities of the second image in the first incident wavelength and the plurality of incident angles;
(7) changing a wavelength of the incident light generated from the light source to another incident wavelength, and rotating at least two of the polarization device, the analyzer and the phase compensator device around the corresponding optical axes in the incident angles such that the intensities of the first images in each of the plurality of incident angles are equal to zero;
(8) recoding rotating angles of the at least two of the polarization device, the analyzer and the phase compensator device around the corresponding optical axes when intensities of the first images equal to zero, and recording intensities of the second image in the rotating angles; and
(9) repeating the steps of (7) and (8), to obtain a profiling diagram representing the intensities of the second images in various incident wavelengths and incident angles, and a maximum intensity of the second images, wherein the maximum intensity corresponds to a maximum grey level.

2. The method according to claim 1, further comprising:
measuring a plurality of standard samples based on the incident angle, the incident wavelength and the rotating angles of maximum intensity of the second image, and obtaining a plurality of intensities corresponding to the images of the plurality of standard samples, wherein the plurality of standard samples represents the thin films annealed with different laser power;
establishing a look-up table, wherein the look-up table represents the relation between the intensities corresponding to the images of the standard samples, power of laser annealing of the plurality of standard samples and carrier nobilities of the plurality of standard samples;
measuring a testing sample based on the incident angles, the incident wavelengths and the rotating angles of maximum intensity of the second image, and obtaining an intensity of the image of the testing sample; and
classifying the testing sample according to the look-up table.

3. An optical inspection system suitable for inspecting a thin film, wherein the thin film comprising a first material and a second material, the optical inspection system comprising:
a light source, configured to generate a light to illuminate the thin film;
a polarization device, disposed in the optical axis between the light source and the thin film and configured to linearly polarize an incident light generated from the light source to have a P-polarization wave and a S-polarization wave;
a phase compensator device, disposed in one of said optical axes and configured to compensate a phase shift between the P-polarization wave and the S-polarization wave caused by one of the first and second materials;
a light sensor, configured to collect a reflected light reflected by the thin film, to form a first image and a second image respectively corresponding to the first material and the second material according to an intensity of the reflected light collected by the light sensor, and to transform the first image and the second image into corresponding electronic signals;
an analyzer, disposed in the optical axis between the thin film and the light sensor;
a controller, configured to receive a set of controlling signals and generate adjusting signals to adjust rotating angles of at least two of the polarization device, the analyzer and the phase compensator device around the corresponding optical axes and adjust incident angles and wavelengths of the light source; and
an electronic computer, coupled between the light sensor and the controller and configured to output the set of controlling signals to control the controller to rotate the rotating angles of at least two of the polarization device, the analyzer and the phase compensator device around the corresponding optical axes in various incident wavelengths and/or incident angles such that intensities of the first images are equal to zero;
wherein the electronic computer further records the rotating angles of the at least two of the polarization device, the analyzer and phase compensator device around the corresponding optical axes when the intensities of the first images are equal to zero and records a plurality of intensities of the second images to obtain a profiling diagram representing the intensities of the second images in various incident wavelengths and incident angles and a maximum intensity of the second images, wherein the maximum intensity corresponds to a maximum grey level.

4. The optical inspection system according to claim 3, wherein:
the optical inspection system measures a plurality of standard samples based on the incident angle, the incident wavelength and the rotating angle of maximum intensity of the second images, and obtaining a plurality of intensities corresponding to images of the plurality of standard samples;
the electronic computer establishes a look-up table, wherein the look-up table represents the relation between the intensities corresponding to the images of the plurality of standard samples, power of laser annealing of the plurality of standard samples and carrier nobilities of the plurality of standard samples;
the optical inspection system measures a testing sample based on the incident angles, the incident wavelengths and the rotating angles of maximum intensity of the second images, and obtaining an intensity of an image of the testing sample; and
the electronic computer classifies the testing sample according to the look-up table.

5. The optical inspection system according to claim 3, wherein the light source is a wideband spectrum surface light source.

6. The optical inspection system according to claim 3, wherein the light sensor further comprises an imaging lens.

7. The optical inspection system according to claim 3, wherein the light sensor is a charge coupled device (CCD) array or a complementary metal oxide (CMOS) semiconductor array.
